(19) United States
(12) Patent Application Publication
(10) Pub. No.: US 2010/0288308 A1
(43) Pub. Date: Nov. 18, 2010

(54) METHOD AND SYSTEM FOR PRODUCING ULTRAPURE WATER, AND METHOD AND SYSTEM FOR WASHING ELECTRONIC COMPONENT MEMBERS

(75) Inventors: Takeo Fukui, Tokyo (JP); Takayuki Moribe, Tokyo (JP); Hitoshi Hotta, Tokyo (JP); Hiroshi Morita, Tokyo (JP)

Correspondence Address: KANESAKA BERNER AND PARTNERS LLP, 1700 DIAGONAL RD, SUITE 310, ALEXANDRIA, VA, 22314-2848, US

(73) Assignee: KURITA WATER INDUSTRIES LTD., Shinjuku-ku, Tokyo (JP)

(21) Appl. No.: 12/734,335

(22) PCT Filed: Nov. 4, 2008
(86) PCT No.: PCT/JP2008/070039

§ 371 Date: Jul. 16, 2010

(30) Foreign Application Priority Data
Nov. 6, 2007 (JP) 2007-288733
Nov. 6, 2007 (JP) 2007-288734

(51) Int. Cl. C02F 1/42; B01J 49/00; B08B 3/10

(52) U.S. Cl. 134/18; 210/263; 210/683; 210/670; 210/685; 134/115 R

(57) ABSTRACT

An ultrapure water production system that can stably produce ultrapure water having a boron concentration of 1 ng/L or less or a metal concentration of 0.1 ng/L or less, a method for producing ultrapure water using the ultrapure water production system, and a method and a system for washing electronic component members. In an ultrapure water production system that includes a mixed-bed deionization apparatus 16, which includes an anion-exchange resin and a cation-exchange resin, as a final deionization apparatus, the anion-exchange resin is an anion-exchange resin that has been verified to have a boron content of 50 μg/L-anion-exchange resin (wet condition) or less or an anion-exchange resin in which the amount of leached cation is 100 μg/L-anion-exchange resin (wet condition) or less.

### FIELD OF INVENTION

The present invention relates to a method and a system for producing ultrapure water and, more particularly, to a method and a system for producing ultrapure water suitable for washing electronic component members in the semiconductor manufacturing industry and the like. The present invention also relates to a method and a system for washing electronic component members with ultrapure water produced with the ultrapure water production system.

### BACKGROUND OF INVENTION

Highly pure water quality is increasingly desired in fields in which ultrapure water is widely used, such as in semiconductor and chemical manufacturing. Impurities in water (ultrapure water) and chemical solutions with which semiconductor substrates and various electronic materials are washed are strictly controlled because the impurities affect the electrical characteristics of silicon substrates of semiconductors and the like.

In general, ultrapure water is produced by treating water to be treated, such as river water, groundwater, and industrial water, in a pretreatment process to remove most of the suspended matter and organic substances in the water to be treated and then sequentially treating the pretreated water in a primary pure water production system and a secondary pure water production system (also referred to as a subsystem). In the secondary pure water production system, primary pure water is treated by a combination of ultraviolet irradiation, ion exchange, ultrafiltration membranes, and the like to remove trace amounts of ions, organic substances, fine particles, and the like remaining in the primary pure water, finally yielding desired ultrapure water. In such an ultrapure water production system, a non-regenerative ion-exchange resin is used for a mixed-bed system in primary pure water production or an ion-exchange apparatus in secondary pure water production. Advantages of using a non-regenerative ion-exchange resin include an increase in the purity of treated water and the elimination of the need for regeneration equipment using a chemical solution. Furthermore, in the secondary pure water production system, any possibility of a chemical solution used for regeneration flowing into the point of use can be eliminated, and an ion-exchange resin that has been purified and highly regenerated under particular conditions can be used.

For example, in the semiconductor manufacturing industry, ultrapure water thus produced is supplied to a point of use at which wafers are washed. Such ultrapure water is not necessarily free from impurities but contains trace impurities, which have influences on products, such as semiconductor devices. With an increase in the degree of integration in devices, trace components in ultrapure water become increasingly significant. Thus, ultrapure water having a higher purity than conventional ultrapure water is required.

Although the requirements specification for the water quality (metal impurity concentration) of ultrapure water is conventionally 1 ng/L or less, such high purity as a metal impurity concentration of 0.1 ng/L or less is presently required.

Japanese Unexamined Patent Application Publication No. 8-84986 describes the production of ultrapure water having a boron concentration of 1 ng/L or less using a boron-selective ion-exchange resin. However, use of a mixed-bed ion-exchange resin located downstream of the boron-selective ion-exchange resin or in combination with the boron-selective ion-exchange resin results in an increase in the boron concentration of ultrapure water because of boron leaching from an anion-exchange resin used in the mixed-bed ion-exchange resin.

Japanese Unexamined Patent Application Publication No. 2005-296839 proposes a method and a system for producing ultrapure water in which the proportion of sodium-type compounds R—Na in a cationic resin of a non-regenerative ion-exchange resin used in a secondary pure water system is set at 0.01% or less to reduce sodium ions leached from the ion-exchange resin into treated water to a very low level, and a method and a system for washing electronic component members using the method and the system for producing ultrapure water.

An actual ultrapure water system includes a mixed-bed deionization apparatus, which includes an anion-exchange resin and a cation-exchange resin, at the final stage. The water quality of ultrapure water is greatly affected by metal leaching from the anion-exchange resin of the mixed-bed deionization apparatus. It is therefore difficult to stably treat water to a metal concentration of 0.1 ng/L or less only by controlling the metal concentration of the cation-exchange resin.

### SUMMARY OF INVENTION

It is a first object of the present invention to provide an ultrapure water production system that can stably produce ultrapure water having a boron concentration of 1 ng/L or less, a method for producing ultrapure water using the ultrapure water production system, and a method and a system for washing electronic component members.

It is a second object of the present invention to provide an ultrapure water production system that can stably produce ultrapure water having a metal concentration of 0.1 ng/L or less, a method for producing ultrapure water using the ultrapure water production system, and a method and a system for washing electronic component members.

An ultrapure water production system according to a first aspect includes a deionization apparatus having an anion-exchange resin, wherein the anion-exchange resin has been analyzed in advance with respect to boron content to verify that the boron content is equal to or less than a specified value.

According to a second aspect, in the ultrapure water production system according to the first aspect, the specified value is 50 μg/L-anion-exchange resin (wet condition).

According to a third aspect, in the ultrapure water production system according to the first or second aspect, the deionization apparatus is a mixed-bed deionization apparatus having the anion-exchange resin and a cation-exchange resin and is installed as a final deionization apparatus.

A method for producing ultrapure water according to a fourth aspect involves use of a deionization apparatus having an anion-exchange resin, wherein the anion-exchange resin has been analyzed in advance with respect to an amount of leached boron to verify that the amount of leached boron is equal to or less than a specified value.

A method for producing ultrapure water according to a fifth aspect involves use of an ultrapure water production system according to any one of the first to third aspects.

According to a sixth aspect, in the method for producing ultrapure water according to the fourth or fifth aspect, the anion-exchange resin is an anion-exchange resin that has been regenerated using an alkaline agent having a boron concentration of 10 μg/L or less such that the anion-exchange resin has a boron content equal to or less than the specified value.

According to a seventh aspect, in the method for producing ultrapure water according to the sixth aspect, the anion-exchange resin is an anion-exchange resin that has been regenerated using the alkaline agent and then washed with water having a boron concentration of 2 μg/L or less.

A method for washing electronic component members according to an eighth aspect involves washing electronic component members with ultrapure water produced with an ultrapure water production system according to any one of the first to third aspects.

A system for washing electronic component members according to a ninth aspect includes an ultrapure water production system according to any one of the first to third aspects as a wash-water production system.

According to the first to ninth aspects, the amount of boron leached from an anion-exchange resin can be significantly reduced, and therefore ultrapure water having a boron concentration of 1 ng/L or less can be stably produced.

The specified value is preferably 50 μg/L-anion-exchange resin (wet condition), particularly 10 μg/L-anion-exchange resin (wet condition).

The installation of a mixed-bed deionization apparatus having this anion-exchange resin as a final deionization apparatus in an ultrapure water production system allows stable production of ultrapure water having a boron concentration sufficiently lower than 1 ng/L.

An ultrapure water production system according to a tenth aspect includes a deionization apparatus having an anion-exchange resin as a final deionization apparatus, wherein the anion-exchange resin has been analyzed in advance with respect to an amount of leached cation to verify that the amount of leached cation is equal to or less than a specified value.

According to an eleventh aspect, in the ultrapure water production system according to the tenth aspect, the deionization apparatus is a mixed-bed deionization apparatus that includes the anion-exchange resin and a cation-exchange resin.

According to a twelfth aspect, in the ultrapure water production system according to the tenth or eleventh aspect, the specified value is 100 μg/L-anion-exchange resin (wet condition).

According to a thirteenth aspect, the ultrapure water production system according to the eleventh or twelfth aspect, the cation-exchange resin is a cation-exchange resin having an H-type conversion rate of 99.95% or more.

A method for producing ultrapure water according to a, fourteenth aspect involves use of a deionization apparatus having an anion-exchange resin, wherein the anion-exchange resin has been analyzed in advance with respect to an amount of leached cation to verify that the amount of leached cation is equal to or less than a specified value.

A method for producing ultrapure water according to a fifteenth aspect involves use of an ultrapure water production system according to any one of the tenth to thirteenth aspects.

A method for washing electronic component members according to a sixteenth aspect involves washing electronic component members with ultrapure water produced with an ultrapure water production system according to any one of the tenth to thirteenth aspects.

A system for washing electronic component members according to a seventeenth aspect includes an ultrapure water production system according to any one of the tenth to thirteenth aspects as a wash-water production system.

According to the tenth to thirteenth aspects, in an ultrapure water production system that includes a mixed-bed deionization apparatus as a final deionization apparatus, an anion-exchange resin having an amount of leached cation equal to or less than a specified value is used as an anion-exchange resin of the mixed-bed deionization apparatus. This can significantly reduce the amount of metal leached from the anion-exchange resin and allows stable production of ultrapure water having a metal concentration of 0.1 ng/L or less.

The specified value is preferably 100 μg/L-anion-exchange resin (wet condition), particularly 50 μg/L-anion-exchange resin (wet condition).

Use of a cation-exchange resin having an H-type conversion rate of 99.95% or more can reduce the amount of metal ions, particularly sodium ion, leached from the cation-exchange resin, allowing stable production of ultrapure water having a metal ion concentration sufficiently lower than 0.1 ng/L.

### BRIEF DESCRIPTION OF DRAWINGS

FIG. 1 is a flow chart of a pure water production system.

FIG. 2 is a flow chart of a pure water production system.

FIG. 3 is a flow chart of a pure water production system.

### DETAILED DESCRIPTION

Embodiments of the present invention will be described below with reference to the drawings.

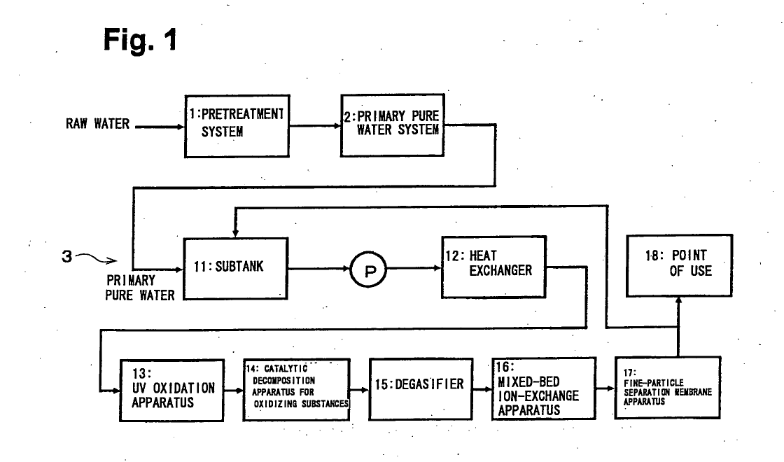

Preferably, an ultrapure water production system according to the present invention includes a mixed-bed deionization apparatus as a final deionization apparatus. FIGS. 1 to 3 are general flow charts of such an ultrapure water production system.

Each of the ultrapure water production systems illustrated in FIGS. 1 to 3 includes a pretreatment system 1, a primary pure water system 2, and a subsystem 3.

Suspended matter and colloidal matter in raw water are removed in the pretreatment system 1, which includes flocculation, pressure flotation (precipitation), and filtration apparatuses. Ions and organic components in raw water are removed in the primary pure water system 2, which includes a reverse osmosis (RO) membrane separator, a degasifier, and a (mixed-bed, two-bed three-tower, or four-bed five-tower) ion-exchange apparatus. The RO membrane separator removes ionic and colloidal TOC as well as salts. The ion-exchange apparatus removes TOC components adsorbed on or ion-exchanged by an ion-exchange resin, as well as salts. The degasifier (nitrogen degassing or vacuum degassing) removes dissolved oxygen.

In the ultrapure water production system illustrated in FIG. 1, primary pure water thus produced (in general, pure water having a TOC concentration of 2 ppb or less) is sequentially passed through a subtank 11, a pump P, a heat exchanger 12, a UV oxidation apparatus 13, a catalytic decomposition apparatus for oxidizing substances 14, degasifier 15, a mixed-bed deionization apparatus (ion-exchange apparatus) 16, and a fine-particle separation membrane apparatus 17. The resulting ultrapure water is supplied to the point of use 18.

The UV oxidation apparatus 13 may generally be a UV oxidation apparatus that can emit UV having a wavelength of approximately 185 nm, which is used in an ultrapure water production system, for example, a UV oxidation apparatus that includes a low-pressure mercury lamp. The UV oxidation apparatus 13 decomposes TOC in the primary pure water into organic acids and further into CO₂. The UV oxidation apparatus 13 also produces H₂O₂ from water by the action of excessive UV.

Water treated with the UV oxidation apparatus is then sent to the catalytic decomposition apparatus for oxidizing substances 14. A catalyst for decomposing oxidizing substances used in the catalytic decomposition apparatus for oxidizing substances 14 may be a noble metal catalyst known as a redox catalyst, for example, a palladium (Pd) compound, such as palladium metal, palladium oxide, or palladium hydroxide, or platinum (Pt). Among these catalysts, a palladium catalyst having a strong reducing effect can be suitably used.

The catalytic decomposition apparatus for oxidizing substances 14 efficiently catalytically decomposes and removes H₂O₂ generated in the UV oxidation apparatus 13 and other oxidizing substances. Although the decomposition of H₂O₂ produces water, unlike an anion-exchange resin or activated carbon, the decomposition rarely produces oxygen and does not cause an increase in DO.

Water treated with the catalytic decomposition apparatus for oxidizing substances 14 is then sent to the degasifier 15. The degasifier 15 may be a vacuum degasifier, a nitrogen degasifier, or a membrane degasifier. The degasifier 15 efficiently removes DO and CO₂ in water.

Water treated with the degasifier 15 is then sent to the mixed-bed ion-exchange apparatus 16. The mixed-bed ion-exchange apparatus 16 is a non-regenerative mixed-bed ion-exchange apparatus filled with an anion-exchange resin and a cation-exchange resin mixed in a ratio that depends on ion loading. The mixed-bed ion-exchange apparatus 16 removes cations and anions in water, thereby increasing the purity of water.

Water treated with the mixed-bed ion-exchange apparatus 16 is then sent to the fine-particle separation membrane apparatus 17. The fine-particle separation membrane apparatus 17 may be a UF membrane separator for use in general ultrapure water production systems. The fine-particle separation membrane apparatus 17 removes fine particles in water, for example, discharged fine particles of an ion-exchange resin from the mixed-bed ion-exchange apparatus 16. Thus, TOC, CO₂, DO, H₂O₂, ionic substances, and fine particles are largely removed to produce high-purity ultrapure water.

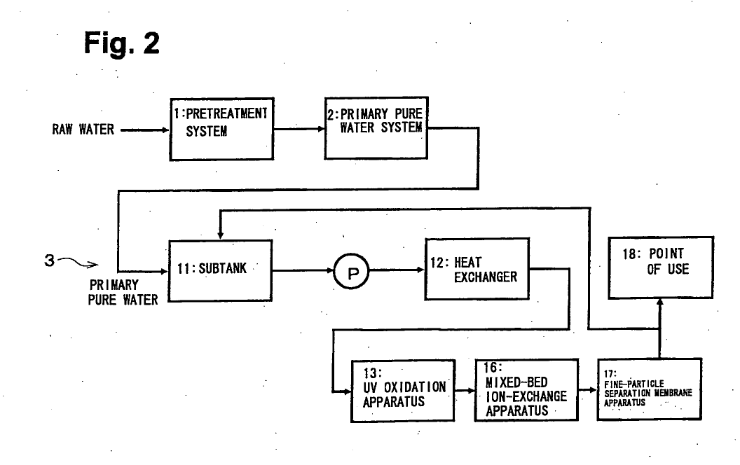

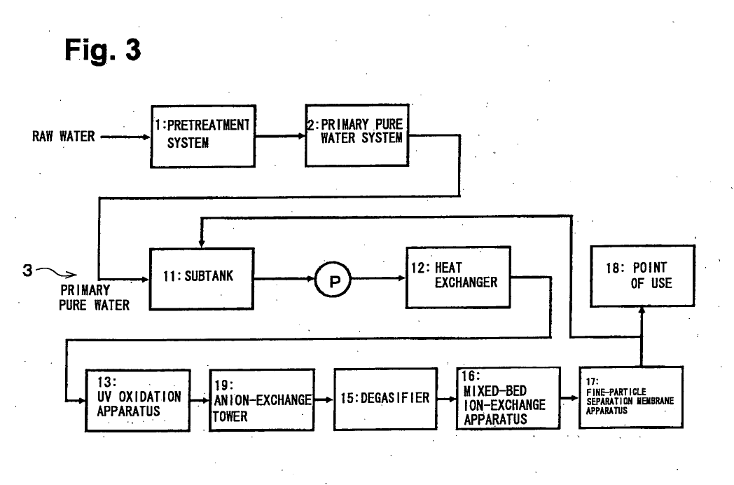

The structure illustrated in FIG. 1 is an example of an ultrapure water production system according to the present invention. Like known systems, an ultrapure water production system according to the present invention includes a pretreatment system, a primary pure water system, and a subsystem. Provided that the subsystem in the series of constituent apparatuses includes a mixed-bed ion-exchange apparatus as a final ion-exchange resin, various apparatuses may be combined. For example, as illustrated in FIG. 2, UV-irradiated water from the UV oxidation apparatus 13 may be directly introduced into the mixed-bed deionization apparatus 16. As illustrated in FIG. 3, the catalytic decomposition apparatus for oxidizing substances 14 may be replaced by an anion-exchange tower 19.

Although not shown in the figures, an RO membrane separator may be installed downstream of the mixed-bed ion-exchange apparatus. Furthermore, an apparatus in which raw water is subjected to thermal decomposition under acidic conditions of pH 4.5 or less in the presence of an oxidizing agent to decompose urea and other TOC components in the raw water and is then deionized may be incorporated. A plurality of UV oxidation apparatuses, mixed-bed ion-exchange apparatuses, and/or degasifiers may be installed. The pretreatment system 1 and the primary pure water system 2 are also not limited to those illustrated in the figures, and various other combinations of apparatuses may be employed.

<<An Embodiment in which the Amount of Boron Leached from an Anion-Exchange Resin is Equal to or Less than a Specified Value>>

### [Boron Content of Anion-Exchange Resin]

In this embodiment, an anion-exchange resin of a final mixed-bed deionization apparatus 16 in an ultrapure water production system is an anion-exchange resin having a boron content equal to or less than a specified value, preferably 50 μg/L-anion-exchange resin (wet condition) or less, particularly preferably 10 μg/L-anion-exchange resin (wet condition) or less.

Such an anion-exchange resin having a low boron concentration can be manufactured by regenerating a commercially available anion-exchange resin or a used anion-exchange resin using a low-boron-concentration alkaline agent having a boron concentration of 10 μg/L or less, preferably 5 μg/L or less, and then by washing (rinsing) the anion-exchange resin with low-boron-concentration ultrapure water having a boron concentration of 2 ng/L or less, preferably 1 ng/L or less.

Examples of the alkaline agent include NaOH, KOH, LiOH, tetramethylammonium hydroxide, and monoethanolamine. Among these, NaOH is preferred.

### [Method for Measuring the Boron Content of Anion-Exchange Resin]

The following is a method for measuring the boron content of an anion-exchange resin.

After an anion-exchange resin to be evaluated is washed with ultrapure water having a boron concentration of 2 ng/L or less, 100 mL of the anion-exchange resin is taken in a clean plastic container. Five hundred milliliters of 4% nitric acid of guaranteed reagent grade is added to the anion-exchange resin and is shaken for one hour. After shaking, the boron concentration of the nitric acid is measured.

The boron content is calculated from the measured value. In this calculation, it is assumed that the whole amount of boron in the anion-exchange resin has leached into the nitric acid. The amount of boron (μg) in the nitric acid is divided by the amount of anion-exchange resin (L) to calculate the boron content. When the boron content is 50 μg/L-anion-exchange resin or less, the anion-exchange resin is considered as an accepted product.

A cation-exchange resin for use in a mixed-bed deionization apparatus preferably has an H-type conversion rate of 99.95% or more to reduce the amount of leached metal, particularly the amount of leached sodium.

The proportion of an anion-exchange resin to the total amount of resins (% by volume) in a mixed-bed deionization apparatus preferably ranges from 80% to 30%, particularly approximately 75% to 50%.

### EXAMPLES AND COMPARATIVE EXAMPLES

Examples and comparative examples of the present invention will be described below.

### Example 1

A commercially available anion-exchange resin A was regenerated using 4% by weight aqueous NaOH having a boron concentration of 1 μg/L and was washed with ultrapure water having a boron concentration of 2 ng/L or less. A hundred milliliter of the anion-exchange resin A was taken in a clean polypropylene container. Five hundred milliliters of high-purity nitric acid (4%) was added to the anion-exchange resin A and was shaken (5 strokes/s) for one hour. The boron concentration of the nitric acid was then measured by inductively coupled plasma mass spectrometry (ICPMS).

The sodium concentration of the resin was calculated by the following equation.

Boron content of resin=[ICPMS measured value (μg/L)×Amount of nitric acid (0.5 L)]/Amount of resin (0.1 L)

After the anion-exchange resin was washed with ultrapure water, 500 mL of the anion-exchange resin was weighed out and mixed with 500 mL of a cation-exchange resin having an H-type conversion rate of 99.95% or more. An acrylic column (having a diameter of 40 mm and a height of 800 mm) was filled with the resins to fabricate a mixed-bed deionization apparatus.

Ultrapure water (having a boron concentration of approximately 2 ng/L) was passed through the mixed-bed deionization apparatus thus fabricated at a flow rate of 2.7 mL/min (SV 160). The boron concentration of the ultrapure water was then measured by inductively coupled plasma mass spectrometry.

Table 1 illustrates the results.

### Comparative Example 1

A test was performed in the same way as in Example 1 except that an aqueous NaOH used for regeneration had a boron concentration of 25 μg/L. Table 1 shows the results.

### Example 2 and Comparative Example 2

A test was performed in the same way as in Example 1 and Comparative Example 1 except, that another commercially available anion-exchange resin B was used. Table 1 shows the results.

### Example 3 and Comparative Example 3

A test was performed in the same way as in Example 1 and Comparative Example 1 except that still another commercially available anion-exchange resin C was used. Table 1 shows the results.

TABLE 1

| | | Boron | Boron |
|---|---|---|---|
| | | content of | concentration of water |
| | | anion-exchange | treated with mixed-bed |
| | Anion-exchange | resin | deionization apparatus |
| | resin | (μg/L-AR) | (ng/L) |
| Example 1 | A | 30 | 0.6 |
| Comparative | A | 300 | 1.6 |
| Example 1 | | | |
| Example 2 | B | 60 | 0.75 |
| Comparative | B | 250 | 1.4 |
| Example 2 | | | |
| Example 3 | C | 90 | 0.95 |
| Comparative | C | 200 | 1.2 |
| Example 3 | | | |

As is clear from the results shown in Table 1, the selection of an anion-exchange resin having a boron content of 50 μg/L-anion-exchange resin (wet condition) or less and the use of the anion-exchange resin in a mixed-bed deionization apparatus of a subsystem allow the production of ultrapure water having a boron concentration of 1 ng/L or less.

<<An Embodiment in which the Amount of Cation Leached from An Anion-Exchange Resin is Equal to or Less than a Specified Value>>

In this embodiment, an anion-exchange resin of a final mixed-bed deionization apparatus 16 in an ultrapure water production system is an anion-exchange resin having an amount of leached cation equal to or less than a specified value, preferably 100 μg/L-anion-exchange resin (wet condition) or less, particularly preferably 50 μg/L-anion-exchange resin (wet condition) or less. The following is a method for measuring and evaluating the amount of leached cation.

### [Method for Measuring and Evaluating the Amount of Leached Cation]

After an anion-exchange resin to be evaluated is washed with ultrapure water, 100 mL of the anion-exchange resin is taken in a clean plastic container. Five hundred milliliters of 4% high-purity hydrochloric acid for analytical use is added to the anion-exchange resin and is shaken for one hour. After shaking, the metal concentration of the hydrochloric acid is measured.

The amount of leached metal per unit amount of resin is calculated from the measured value. When this amount of leached metal is 100 μg/L-anion-exchange resin or less, the anion-exchange resin is considered as an accepted product.

A cation-exchange resin for use in a mixed-bed deionization apparatus preferably has an H-type conversion rate of 99.95% or more to reduce the amount of leached metal, particularly the amount of leached sodium.

The proportion of an anion-exchange resin to the whole resin (% by volume) in a mixed-bed deionization apparatus preferably ranges from 80% to 30%, particularly approximately 75% to 50%.

### Examples and Comparative Examples

Examples and comparative examples of the present invention will be described below.

### EXAMPLES 4 to 7 and COMPARATIVE EXAMPLES 4 and 5

After commercially available anion-exchange resins D to I were washed with ultrapure water, 100 mL of each of the anion-exchange resins was taken in a clean polypropylene container. Five hundred milliliters of high-purity hydrochloric acid (4%) was added to the anion-exchange resin and was shaken (5 strokes/s) for one hour. The metal concentration of the hydrochloric acid was then measured by inductively coupled plasma mass spectrometry (ICPMS).

The sodium concentration of the resin was calculated by the following equation.

Sodium concentration of resin=[ICPMS measured value (μg/L)×Amount of hydrochloric acid (0.5 L)]/Amount of resin (0.1 L)

After the anion-exchange resin was washed with ultrapure water, 500 mL of the anion-exchange resin was weighed out and mixed with 500 mL of a cation-exchange resin having an H-type conversion rate of 99.95% or more. An acrylic column (having a′ diameter of 40 mm and a height of 800 mm) was filled with the resins to fabricate a mixed-bed deionization apparatus.

Ultrapure water (having a Na concentration of approximately 0.1 ng/L) was passed through the mixed-bed deionization apparatus thus fabricated at a flow rate of 833 mL/min (SV 50). After preconcentration, the metal concentration of the ultrapure water was measured by inductively coupled plasma mass spectrometry.

Table 2 illustrates the results.

TABLE 2

| | | Na in | Metal |
|---|---|---|---|
| | | hydrochloric | concentrarion in water |
| | | acid | treated with mixed-bed |
| | Anion-exchange | after shaking | deionization apparatus |
| | resin | (μg/L-AR) | (ng/L) |
| Comparative | D | 440 | 0.2 |
| Example 4 | | | |
| Example 4 | E | 0.3 | 0.02 |
| Example 5 | F | 10 | 0.03 |
| Example 6 | G | 40 | 0.05 |
| Example 7 | H | 80 | 0.08 |
| Comparative | I | 120 | 0.1 |
| Example 5 | | | |

As is clear from the results shown in Table 2, the selection of an anion-exchange resin having an amount of leached cation of 100 μg/L-anion-exchange resin (wet condition) or less and the use of the anion-exchange resin in a mixed-bed deionization apparatus of a subsystem allow the production of ultrapure water having a metal concentration of 0.1 ng/L or less.

While the present invention was described in detail with particular embodiments, it is apparent to a person skilled in the art that various modifications can be made without departing from the spirit and the scope of the present invention.

The present application is based on Japanese Patent Application (Japanese Patent Application No. 2007-288733) filed on Nov. 6, 2007 and Japanese Patent Application (Japanese Patent Application No. 2007-288734) filed on Nov. 6, 2007, which are incorporated herein by reference in their entirety.

1. An ultrapure water production system comprising a deionization apparatus having an anion-exchange resin,
wherein the anion-exchange resin has been analyzed in advance with respect to boron content or an amount of leached cation to verify that the boron content or the amount of leached cation is equal to or less than a specified value.

2. The ultrapure water production system according to claim 1, wherein the specified value for the boron content is 50 μg/L-anion-exchange resin (wet condition).

3. The ultrapure water production system according to claim 1, wherein the specified value for the amount of leached cation is 100 μg/L-anion-exchange resin (wet condition).

4. The ultrapure water production system according to claim 3, wherein the cation-exchange resin is a cation-exchange resin having an H-type conversion rate of 99.95% or more.

5. The ultrapure water production system according to claim 1, wherein the deionization apparatus is a mixed-bed deionization apparatus having the anion-exchange resin and a cation-exchange resin and is installed as a final deionization apparatus.

6. A method for producing ultrapure water, comprising use of a deionization apparatus having an anion-exchange resin, wherein the anion-exchange resin has been analyzed in advance with respect to an amount of leached boron to verify that the amount of leached boron is equal to or less than a specified value.

7. A method for producing ultrapure water, comprising use of a deionization apparatus having an anion-exchange resin, wherein the anion-exchange resin has been analyzed in advance with respect to an amount of leached cation to verify that the amount of leached cation is equal to or less than a specified value.

8. A method for producing ultrapure water, comprising use of an ultrapure water production system according to claim 1.

9. The method for producing ultrapure water according to claim 6, wherein the anion-exchange resin is an anion-exchange resin that has been regenerated with an alkaline agent having a boron concentration of 10 μg/L or less such that the anion-exchange resin has a boron content equal to or less than the specified value.

10. The method for producing ultrapure water according to claim 9, wherein the anion-exchange resin is an anion-exchange resin that has been regenerated with the alkaline agent and then washed with water having a boron concentration of 2 μg/L or less.

11. A method for washing electronic component members, comprising washing electronic component members with ultrapure water produced with an ultrapure water production system according to claim 1.

12. A system for washing electronic component members, comprising an ultrapure water production system according to claim 1 as a wash-water production system.
